(19) United States
(12) Patent Application Publication
(10) Pub. No.: US 2026/0260947 A1
(43) Pub. Date: Sep. 3, 2026

(54) CONTAMINATION DETECTION IN MANUFACTURING USING RAMAN SPECTROSCOPY

(71) Applicant: FORD GLOBAL TECHNOLOGIES, LLC, Dearborn, MI (US)

(72) Inventors: Ann Elizabeth O'Neill, Dearborn, MI (US); Wenhui Zhu, Northville, MI (US); Minja Seo, Novi, MI (US); Brian Joseph Robert, St. Clair Shores, MI (US)

(73) Assignee: FORD GLOBAL TECHNOLOGIES, LLC, Dearborn, MI (US)

(21) Appl. No.: 19/066,971

(22) Filed: Feb. 28, 2025

(51) Int. Cl. H01M 10/058; G01N 21/65; G01N 21/89; G01N 21/898; G08B 21/18; H01M 4/04

(52) U.S. Cl. CPC H01M 10/058; G01N 21/65; G01N 21/8914; G01N 21/898; G08B 21/182; H01M 4/0435

(57) ABSTRACT

A contamination-detection system detects contaminants during lithium-ion or solid-state battery manufacturing using Raman spectroscopy. The contamination-detection system includes a manufacturing line with multiple electrode material processing stations and Raman spectroscopy units positioned at various stations to scan materials and generate spectra. A computing subsystem receives these spectra, compares them with a stored spectral library of reference materials and known contaminants, and identifies potential matches. If a contaminant is detected, the contamination-detection system triggers an alarm or halts production and alerts operators via an integrated notification system. This ensures real-time quality control and prevents defective products.

### TECHNICAL FIELD

In at least one aspect, the present invention is related to systems and methods for detecting contaminants at various stations in lithium-ion or solid-state battery manufacturing.

### BACKGROUND

Detection of magnetic impurities in lithium iron phosphate (LFP) slurry using Raman spectroscopy is a known method in lithium-ion battery manufacturing, but it has significant limitations. The process involves manual sampling with a magnetic rod, washing the sample, and performing Raman analysis in an enclosed system under controlled lighting conditions. This method is restricted to detecting magnetic impurities, is not integrated into manufacturing lines, and is designed primarily for precursor material checks before slurry preparation. The manual operations required, including focusing and spectrum acquisition, are time-consuming, prone to errors, and unsuitable for high-throughput manufacturing or real-time quality control. Additionally, the preparation time for LFP slurry samples can extend up to 72 hours, making it inefficient for broader applications. These constraints limit its flexibility and scalability, restricting its use to narrow chemistries such as LFP.

### SUMMARY

In at least one aspect, a contamination-detection system detects contaminants during lithium-ion or solid-state battery manufacturing using Raman spectroscopy. The contamination-detection system includes a manufacturing line with multiple electrode material processing stations and Raman spectroscopy units positioned at various stations to scan materials and generate spectra. A computing subsystem receives these spectra, compares them with a stored spectral library of reference materials and known contaminants, and identifies potential matches. If a contaminant is detected, the contamination-detection system triggers an alarm or halts production and alerts operators via an integrated notification system. This ensures real-time quality control and prevents defective products.

In another aspect, a system is provided for detecting contaminants during a manufacturing process for lithium-ion or solid-state batteries. The system comprises a manufacturing line with multiple stations for electrode material processing, including slurry preparation, coating and drying, calendaring, slitting, laminating, notching, and stacking. Raman spectroscopy units are positioned at one or more stations of the manufacturing line, including those for coating and drying, calendaring, slitting, laminating, notching, and stacking. These units are configured to scan materials and generate Raman spectra. A spectral library is stored in a computing subsystem and includes reference spectra of expected materials and known contaminants. The computing subsystem is further configured to receive Raman spectra from the Raman spectroscopy units as received spectra, compare the received spectra with the reference spectra in the spectral library to identify contaminants, and trigger an alarm or halt the manufacturing process when a match with a contaminant spectrum is identified. An alert system is further included to notify operators of detected contaminants.

In another aspect, a method is provided for detecting contaminants during a manufacturing process for lithium-ion or solid-state batteries. The method comprises providing a manufacturing line with multiple stations, including slurry preparation, coating and drying, calendaring, slitting, laminating, notching, and stacking. Raman spectroscopy units are positioned at one or more manufacturing stations to scan materials and generate Raman spectra. The generated Raman spectra are compared with a spectral library containing reference spectra of expected materials and known contaminants. Contaminants are identified based on matches between the generated Raman spectra and the reference spectra in the spectral library. When contaminants are detected, an alarm is triggered, or the manufacturing process is halted to prevent further processing of contaminated materials.

In another aspect, contaminants detectable by the system and method include iron phosphide, magnetic metals, lithium carbonate (Li₂CO₃), and material-specific impurities associated with lithium iron phosphate (LFP), nickel manganese cobalt oxide (NMC), and solid-state battery chemistries.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be had to the following detailed description, read in conjunction with the following drawings, wherein like reference numerals denote like elements and wherein:

FIG. 1. Schematic of a system for detecting contaminants during a manufacturing process for lithium-ion or solid-state batteries.

FIG. 2. Schematic of a design for Raman sampling of slurry before coating.

FIG. 3. Schematic illustrating selective and periodic Raman sampling.

### DETAILED DESCRIPTION

Reference will now be made in detail to presently preferred compositions, embodiments, and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

The phrase “composed of” means “including” or “comprising.” Typically, this phrase is used to denote that an object is formed from a material.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4. . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

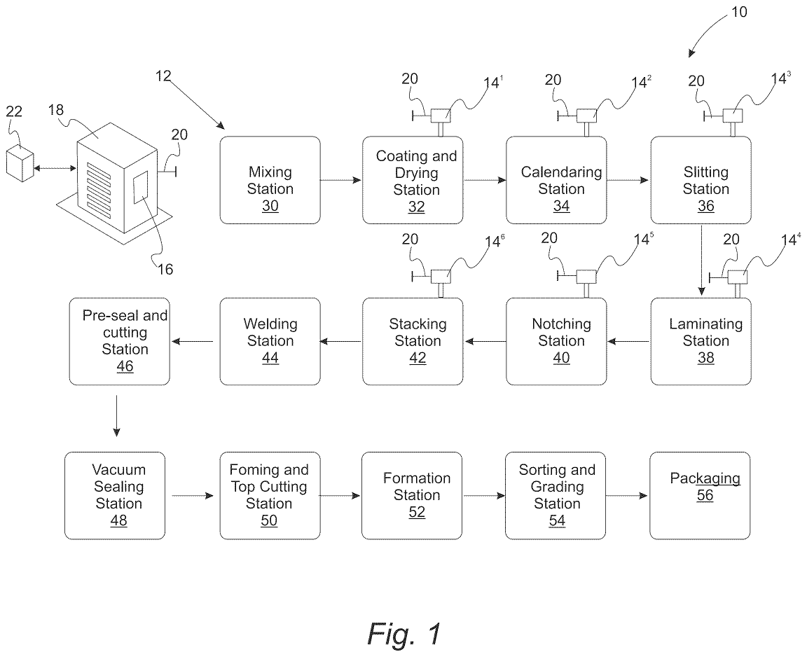

In at least one aspect, a system for detecting contaminants during a manufacturing process for lithium-ion or solid-state batteries is provided. Referring to FIG. 1, the detection system 10 includes a manufacturing line 12 that comprises multiple stations for electrode material processing. Raman spectroscopy units 14ⁱ are positioned at one or more stations of the manufacturing line and are configured to scan materials to generate Raman spectra. Materials scanned (i.e., samples or sample regions) can be liquids, solids, or combinations thereof (e.g., a slurry). Samples can also be gaseous. The superscript i is an integer label differentiating the Raman spectroscopy units. A spectral library 16 is stored in a computing subsystem 18. Characteristically, the spectral library includes reference spectra of expected materials and known contaminants. The computing subsystem 18 is configured to receive Raman spectra from the Raman spectroscopy units 14ⁱ as received spectra, compare the received spectra with the reference spectra in the spectral library 16 to identify contaminants, and trigger an alarm for halting the manufacturing process when a match with a contaminant spectrum is identified. Therefore, computing subsystem 18 can be in electrical communication with each of Raman spectroscopy units 14ⁱ via control lines 20. In a refinement, an alert system 22 is configured to notify operators of detected contaminants. The alert system 22 is configured to provide real-time notifications to a remote quality assurance team. This enables immediate corrective actions and enhances overall process efficiency.

In another aspect, the computing subsystem 18 uses machine learning algorithms to enhance the identification of contaminants over time. This adaptive functionality increases the accuracy and efficiency of the detection process.

Advantageously, detection system 10 can detect a wide range of contaminants in battery manufacturing, including magnetic particles like iron phosphide and other magnetic metals, as well as non-magnetic impurities such as lithium carbonate (Li₂CO₃), which forms on lithium lanthanum zirconium oxide (LLZO) when exposed to air, binding lithium to carbon dioxide and rendering it unusable. It is adaptable to various battery chemistries, such as lithium iron phosphate (LFP), nickel manganese cobalt oxide (NMC), and solid-state cells, identifying material-specific impurities and unexpected surface contaminants by analyzing deviations in Raman spectra. Unlike prior art, which is limited to detecting magnetic impurities in LFP slurries, this system can monitor contaminants at multiple stages of manufacturing, including slurries, electrode coating sheets, and notched electrodes, offering broader application and enhanced quality control.

In another aspect, the Raman spectroscopy units 14ⁱ operate under ambient lighting conditions without interference. This configuration allows for seamless integration into existing manufacturing environments without requiring specialized lighting.

Still referring to FIG. 1, manufacturing line 12 can include mixing station 30, coating and drying station 32, calendaring station 34, slitting station 36, laminating station 38, notching station 40, stacking station 42, welding station 44, pre-seal and cutting station 46, vacuum sealing station 48, forming and top cutting station 50, formation station 52, sorting and grading station 54, and packaging station 56. In a refinement, any combination of coating and drying station 32, calendaring station 34, slitting station 36, laminating station 38, notching station 40, stacking station 42 can have an associated Raman spectroscopy unit 14ⁱ.

Still referring to FIG. 1, at mixing station 30, the active materials (e.g., lithium compounds for cathodes, graphite for anodes), binders, conductive additives, and solvents are blended into a homogenous slurry. This slurry must have precise consistency to ensure even application during coating. Advanced mixers are used to achieve uniform particle dispersion and eliminate agglomerates, as uneven mixtures can lead to poor battery performance.

At the coating and drying station 32, the slurry prepared during mixing is applied onto metal foils-typically aluminum for cathodes and copper for anodes-using precision coating equipment. The coated electrodes are then dried to remove the solvent, leaving behind a thin layer of active material adhered to the current collector. Uniform coating thickness is essential for consistent battery performance. Raman spectroscopy unit 14¹ is associated with coating and drying station 32. Raman spectroscopy unit 14¹ can be positioned at a coating and drying station 32 to scan and monitor electrode coating material for contaminants and uniformity and to ensure that any impurities introduced during the drying phase are identified and addressed.

At the calendaring station 34, the coated electrodes undergo calendaring, where they are passed through rollers to compress the material to a uniform thickness and density. This process enhances the contact between particles, increasing electrical conductivity and optimizing energy density. Proper calendaring also ensures the mechanical integrity of the electrodes. Raman spectroscopy unit 14² is associated with calendaring station 34. Raman spectroscopy unit 14² can be positioned at a calendaring station to analyze contaminants in calendared electrode sheets. This aspect helps maintain the quality of compressed electrode sheets by identifying potential contaminants.

At slitting station 36, the coated electrode sheets are slit into narrower strips suitable for the battery cell design. This step requires high precision to produce clean, burr-free edges that minimize the risk of short circuits and ensure smooth assembly in subsequent steps. Raman spectroscopy unit 14³ is associated with slitting station 36. Raman spectroscopy unit 14³ can be positioned at a slitting station to detect contaminants introduced during a slitting process. This ensures the quality of electrode strips before further processing.

At laminating station 38, a laminating step involves stacking or layering the cathode, separator, and anode to form the core structure of the battery cell. For pouch cells or prismatic cells, this process aligns the layers for consistent electrochemical performance. Solid-state batteries may involve additional precision in layering due to the unique properties of solid electrolytes. Raman spectroscopy unit 14⁴ is associated with laminating station 38. Raman spectroscopy unit 14⁴ is positioned at a laminating station to scan and identify contaminants in laminated materials. This aspect provides additional quality control for composite layers in the manufacturing process.

At notching station 40, electrodes are shaped into specific configurations during a notching step. This process trims unnecessary material and creates electrode shapes that fit seamlessly into the cell casing. Precision in notching reduces material waste and ensures consistent quality in cell assembly. Raman spectroscopy unit 14⁵ is associated with notching station 40. Raman spectroscopy unit 14⁵ can be positioned at a notching station to detect contaminants in notched electrode sheets. This ensures that the electrode sheets meet quality standards before stacking.

At stacking station 42, a stacking process assembles multiple layers of cathode, separator, and anode into a cohesive unit. Each layer is aligned to reduce defects, such as misalignment or shorts, which could affect performance. In cylindrical batteries, this step may involve rolling the layers into a spiral configuration. Raman spectroscopy unit 14⁶ is associated with stacking station 42. Raman spectroscopy unit 14⁶ can be positioned at a stacking station to monitor purity and integrity of electrode layers in a final stack. This aspect verifies the quality of the finished electrode assembly.

Still referring to FIG. 1, at welding station 44, tabs are welded onto the electrodes to establish reliable electrical connections. Welding techniques such as ultrasonic, laser, or resistance welding are used to minimize electrical resistance and ensure robust mechanical bonds. These connections are critical for efficient current flow within the battery. At pre-seal and cutting station 46, pre-sealing is performed to stabilize the structure and prepare it for electrolyte filling. Excess material is trimmed, and the edges are sealed to form a leak-proof enclosure. This step ensures the structural integrity of the cell during subsequent processes. At vacuum sealing station 48, cells are sealed under vacuum conditions to remove any residual air or moisture. This step is critical for preventing contamination, which could degrade the battery over time. Vacuum sealing also ensures that the electrolyte for lithium-ion batteries, once added, remains in a controlled environment. At forming and top cutting station 50, battery cells are shaped into their final dimensions (i.e., forming), and any excess material is trimmed to create a clean, uniform structure. This step also ensures that the cell meets the mechanical and dimensional requirements for its intended application. At formation station 52, a formation step is performed. The formation is the initial charging and discharging cycle of the battery. This process stabilizes the electrodes and forms a solid electrolyte interface (SEI) on the anode, which is crucial for long-term performance and stability. The formation is done under carefully controlled conditions to optimize the electrochemical properties of the cell. At sorting and grading station 54, cells are evaluated for key performance parameters such as capacity, resistance, and voltage. Based on the results, the cells are sorted and graded into categories. High-performing cells are used in premium applications, while lower-performing cells may be repurposed or recycled. At packaging station 56, the battery cells are encapsulated in protective casings and external connectors attached for integration into larger battery packs. Packaging includes adding features, such as pressure-relief valves and insulation layers, as well as labeling for traceability. This step ensures the battery is ready for transportation and use.

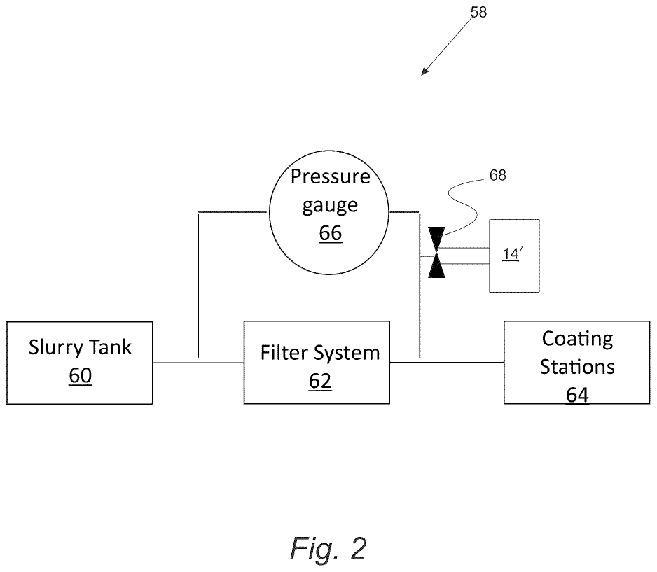

In another aspect, detection system 10 includes Raman spectroscopy unit 14⁷ positioned at a slurry preparation station 58 to monitor for homogeneity and detect contaminants in a slurry. This positioning ensures early-stage quality control during the manufacturing process. FIG. 2 depicts an arrangement for monitoring samples from the slurry tank 60, which is in fluid communication with the filtering system 62. Filtering system 62 provides filtered slurry to coating station 64. Pressure gauge 66 has ports connected to the inlet and outlet of filtering system 62. Filtering system 62 is installed after the slurry tank to ensure that the output meets the required quality before moving to the coating process. This system plays a critical role in maintaining the consistency of the slurry and ensuring that only properly mixed and appropriately sized particles proceed to the next stage. It helps ensure particle size uniformity, removes foreign contaminants, and breaks down any clumps or agglomerates that may have escaped during the mixing phase. Additionally, the filtering system protects downstream equipment, such as the coating and drying machines, from blockages caused by oversized or unwanted particles. Raman sampling output 68 provides a sample to a Raman spectroscopy unit 14⁷ drawn after filtering system 62.

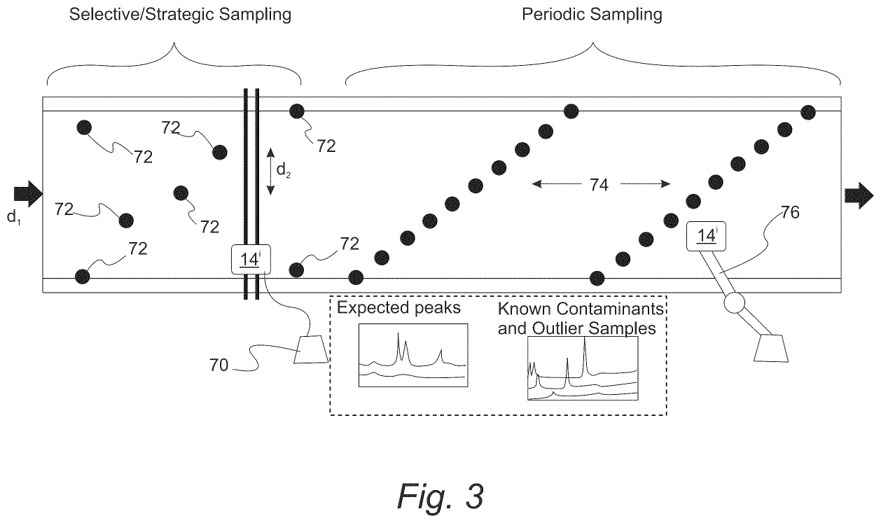

Referring to FIG. 3, selective and periodic Raman sampling are depicted. Samples or sample regions to be measured move along direction d₁. With respect to selective or strategic samples, a mobile Raman 14ⁱ is configured to translate along direction d₂ under the control of controller 70. Raman spectroscopy unit 14ⁱ samples the samples at programmed scanning positions 72. In another variation, Raman spectroscopy unit 14ⁱ is configured to perform periodic sampling at periodic positions 74. In a refinement, Raman spectroscopy unit 14ⁱ is positioned on a programmable positioning arm 76.

Referring to FIG. 1, a method for detecting contaminants during the manufacturing process for lithium-ion or solid-state batteries is provided. The method includes providing a manufacturing line 12 comprising multiple stations, including slurry preparation, coating, drying, calendaring, slitting, laminating, notching, and stacking. Raman spectroscopy units 14ⁱ are positioned at one or more manufacturing stations 32 to 42, as described above. The method further involves scanning materials at the respective stations using the Raman spectroscopy units 14ⁱ, generating Raman spectra, comparing the generated Raman spectra with a spectral library 16 containing reference spectra of expected materials and known contaminants, identifying contaminants based on matches between the generated Raman spectra and the reference spectra in the spectral library 16, and triggering an alarm for halting the manufacturing process when contaminants are detected. Raman sampling can be selective or periodic as depicted in FIG. 3.

In another aspect of the method, Raman spectroscopy unit 14¹ is positioned at a coating station and drying station 32 to monitor for contaminants and ensure uniformity of the electrode coating material as described above.

In another aspect of the method, a Raman spectroscopy unit 14² is positioned at a calendaring station 34 to analyze contaminants in calendared electrode sheets as described above.

In another aspect of the method, a Raman spectroscopy unit 14³ is positioned at the slitting station 36 to detect contaminants introduced during shaping or cutting processes.

In another aspect of the method, a Raman spectroscopy unit 14⁴ is positioned at laminating station 38 to scan and identify contaminants in laminated materials as described above.

In another aspect of the method, a Raman spectroscopy unit 14⁵ is positioned at a notching station 40 to station to detect contaminants in notched electrode sheets as described above.

In another aspect of the method, a Raman spectroscopy unit 14⁶ positioned at a stacking station 42 ensures the purity and integrity of electrode layers in a final battery stack as described above.

In another aspect of the method, a Raman spectroscopy unit 14⁷ positioned at a slurry preparation station 58 scans for homogeneity and detects contaminants in a slurry before it is applied as a coating as described above.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system for detecting contaminants during a manufacturing process for lithium-ion or solid-state batteries, comprising:
a manufacturing line comprising multiple stations for electrode material processing;
Raman spectroscopy units positioned at one or more stations of the manufacturing line, the Raman spectroscopy units configured to scan materials to generate Raman spectra;
a computing subsystem configured to:
store a spectral library comprising reference spectra of expected materials and known contaminants;
receive Raman spectra from the Raman spectroscopy units as received spectra; and
compare the received spectra with the reference spectra in the spectral library to identify contaminants; and
trigger an alarm or halt the manufacturing process when a match with a contaminant spectrum is identified; and
an alert system configured to notify operators of detected contaminants.

2. The system of claim 1 wherein detectable contaminants include iron phosphide, magnetic metals, lithium carbonate (Li₂CO₃), and material-specific impurities associated with lithium iron phosphate (LFP), nickel manganese cobalt oxide (NMC), and solid-state battery chemistries.

3. The system of claim 1, wherein the Raman spectroscopy units are positioned at a slurry preparation station to monitor for homogeneity and detect contaminants in a slurry.

4. The system of claim 1, wherein the Raman spectroscopy units are positioned at a coating and drying station to scan and monitor electrode coating material for contaminants and uniformity.

5. The system of claim 1, wherein the Raman spectroscopy units are positioned at a calendaring station to analyze contaminants in calendared electrode sheets.

6. The system of claim 1, wherein the Raman spectroscopy units are positioned at a slitting station to detect contaminants introduced during a slitting process.

7. The system of claim 1, wherein the Raman spectroscopy units are positioned at a laminating station to scan and identify contaminants in laminated materials.

8. The system of claim 1, wherein the Raman spectroscopy units are positioned at a notching station to detect contaminants in notched electrode sheets.

9. The system of claim 1, wherein the Raman spectroscopy units are positioned at a stacking station to monitor purity and integrity of electrode layers in a final stack.

10. The system of claim 1, wherein the alert system is configured to provide real-time notifications to a remote quality assurance team.

11. The system of claim 1, wherein the computing subsystem uses machine learning algorithms to enhance identification of contaminants over time.

12. The system of claim 1, wherein the Raman spectroscopy units operate under ambient lighting conditions without interference.

13. A system for detecting contaminants during a manufacturing process for lithium-ion or solid-state batteries, comprising:
a manufacturing line comprising multiple stations for electrode material processing, including a slurry preparation station, a coating and drying station, a calendaring station, a slitting station, a laminating station, a notching station, and a stacking station;
Raman spectroscopy units positioned at one or more stations of the manufacturing line, including stations for coating and drying, calendaring, slitting, laminating, notching, and stacking, the Raman spectroscopy units configured to scan materials to generate Raman spectra;
a computing subsystem configured to:
store a spectral library comprising reference spectra of expected materials and known contaminants;
receive Raman spectra from the Raman spectroscopy units as received spectra;
compare the received spectra with the reference spectra in the spectral library to identify contaminants; and
trigger an alarm or halt the manufacturing process when a match with a contaminant spectrum is identified; and
an alert system configured to notify operators of detected contaminants.

14. A method for detecting contaminants during manufacturing process for lithium-ion or solid-state batteries, comprising:
providing a manufacturing line comprising multiple stations, including slurry preparation, coating and drying, calendaring, slitting, laminating, notching, and stacking;
positioning Raman spectroscopy units at one or more manufacturing stations;
scanning materials at the respective stations using the Raman spectroscopy units to generate Raman spectra;
comparing generated Raman spectra with a spectral library containing reference spectra of expected materials and known contaminants;
identifying contaminants based on matches between the generated Raman spectra and the reference spectra in the spectral library; and
triggering an alarm or halting the manufacturing process when contaminants are detected.

15. The method of claim 14, wherein a Raman spectroscopy unit at a slurry preparation station scans for homogeneity and detects contaminants in a slurry before it is applied as a coating.

16. The method of claim 14, wherein a Raman spectroscopy unit at a coating and drying station monitors for contaminants and ensures uniformity of electrode coating material.

17. The method of claim 14, wherein a Raman spectroscopy unit at a calendaring station detects contaminants in calendared electrode sheets.

18. The method of claim 14, wherein a Raman spectroscopy unit at a notching station or slitting station detects contaminants introduced during shaping or cutting processes.

19. The method of claim 14, wherein a Raman spectroscopy unit at a stacking station ensures purity and integrity of electrode layers in a final battery stack.

20. The method of claim 14, wherein Raman sampling is selective or periodic.
